(19) United States
(12) Patent Application Publication
(10) Pub. No.: US 2006/0062923 A1
(43) Pub. Date: Mar. 23, 2006

(54) Methods for short term protection of automotive surfaces and compositions for use therein

(76) Inventors: Colin M. Dilley, Thomaston, CT (US); David L. Balog, Naugatuck, CT (US); Laurie A. Gallagher, New Milford, CT (US)

Correspondence Address: Honeywell International Inc.;Law Department Patent Services, 101 Columbia Road, Morristown, NJ, 07962, US

(21) Appl. No.: 11/223,818

(22) Filed: Sep. 9, 2005

Related U.S. Application Data
(60) Provisional application No. 60/608,615, filed on Sep. 10, 2004.

(51) Int. Cl. B05D 3/02; C11D 3/37

(52) U.S. Cl. 427/372.2; 510/189

(57) ABSTRACT

Disclosed are methods of providing short-term protection to an automobile exterior. In one embodiment, the method comprises applying an aqueous film-forming automotive coating composition to an automobile exterior; drying the aqueous film-forming automotive coating composition at ambient conditions to form a protective coating that does not substantially alter the gloss or color of the automobile exterior; and removing the protective coating after a period of time post-application in a manner that does not result in damage to the automobile exterior and produces a biodegradable waste stream. A two component package is also provided, the package comprising an aqueous film-forming automotive coating composition comprising a film-forming polymer and a solvent; and an aqueous wash removal composition that is at least one of a surfactant wash, a solvent wash, a solvent surfactant wash, or a combination thereof. In another embodiment, a curable coating composition is applied and cured by natural sunlight.

### CROSS-REFERENCE TO RELATED APPLICATIONS

This application claims the benefit of U.S. Provisional Application Ser. No. 60/608,615, filed on Sep. 10, 2004, which is hereby incorporated by reference in its entirety.

### BACKGROUND

It is known in the automotive industry that the surface paint finishes of automobiles are subject to a variety of injuries both during the assembly process and during transportation from the assembly plant to retail locations. These finishes may be especially prone to damage in the post manufacturing period because the paint may not be sufficiently cured. The damage inflicted on the surface finish of an automobile during transit can be quite severe. In some case, shipment back to the assembly plant for repainting may be necessary. It will be appreciated that transport damage to recently manufactured vehicles is costly in terms of time, money and efficiency. It would therefore be desirable to provide methods for preventing damage to automotive exterior finishes during post manufacturing transport.

In addition to damage during transit, automobiles may suffer exterior damage during their lifetimes as a result of normal usage. Such damage can occur in a number of different ways. In addition to damage from road debris, automobiles often experience significant weathering damage. Weathering effects may result directly from sun, wind, rain, hail, ice, sleet, and the like, or may result from efforts to mitigate specific weathering effects.

For example, winter is particularly hard on automotive exteriors. In addition to the harsh effects of cold, snow, ice, sleet, and ice, the sand and salt used to provide traction on winter roads has been found to be particularly damaging in regards to automotive exterior finishes. Such winter traction aids may linger on road surfaces for many months. It is would therefore be advantageous to protect automobile exteriors from the effects of weathering damage, especially damage from winter weather and winter road traction aids. Winter is thus a period of greater risk to exterior automotive finishes.

It would therefore be especially advantageous to provide short-term protection against the harsh effects of winter weather and winter road traction aids. Such protection must be easily applied by an average consumer but provide a sufficient barrier against the effects of winter weather and winter road traction aids. On the other hand, any commercially feasible short-term protection must be capable of easy removal by a consumer without damage to the underlying finish and without the production of any hazardous or undesirable waste streams. Finally, during the period of use, the short-term protection must not negatively affect the aesthetic appearance of the exterior automotive finish. Undesirable negative appearance effects include haze, dullness due to loss of gloss, loss of DOI (distinctness of image) and the like.

There have been proposed a number of strippable coating compositions which are applied to the surfaces of an automobile when, for example, the automobile is shipped. After a predetermined period of time, such coatings may be stripped from the automobile.

For example, several types of strippable coating compositions have been described for use on the outer panels of automobiles. One coating is an oily wax type in which paraffin wax is dispersed in a petroleum-based solvent, and the other coating is a type in which a mixture of calcium carbonate powder in paraffin wax is dispersed in a petroleum-based solvent. Another coating is a vinyl-acrylic copolymer emulsion that may be dried on the surface of the automobile and peeled off when no longer desired. Yet another coating includes an acrylic acid copolymer that is coated onto the surface and dried. This coating may be removed by application of an alkaline aqueous detergent solution.

While suitable for their intended purpose, there nonetheless remains a need for additional protective coatings for automobiles.

### SUMMARY

Disclosed are methods of providing short-term protection to an automobile exterior.

In one embodiment, the method comprising applying a layer of a curable automotive coating composition to a portion of an automobile exterior, the curable automotive coating composition comprising a curable acrylate monomer, oligomer, or a combination thereof; a photo-polymerization initiator; and optionally a curable fluorine-containing or sulfur-containing monomer, oligomer, or combination thereof; and exposing the layer to natural sunlight to form a cured layer.

In a second embodiment, the method comprises applying a layer of an aqueous film-forming automotive coating composition to at least a portion of an automobile exterior, the aqueous film-forming automotive coating composition comprising a film-forming polymer and a solvent; drying the aqueous film-forming automotive coating composition at ambient conditions to form a protective coating that does not substantially alter the gloss or color of the automobile exterior; and removing the protective coating after a period of time post application in a manner that does not result in damage to the automobile exterior and produces a biodegradable waste stream.

In one exemplary embodiment, the step of removing the protective coating comprises contacting at least a portion of the protective coating with an aqueous wash removal composition for a period of time sufficient to disrupt adhesion between the protective coating and the automotive exterior, and wiping off the aqueous wash removal composition and protective coating from the automotive exterior.

In another embodiment, the aqueous wash removal composition is at least one of a surfactant wash, a solvent wash, a solvent surfactant wash, or a combination thereof.

Also disclosed is a two-component package for use in the disclosed method of providing short-term protection to an automobile exterior. The two component package comprises in one embodiment, an aqueous film-forming automotive coating composition comprising a film-forming polymer and a solvent; and a concentrate of an aqueous wash removal composition that is at least one of a surfactant wash, a solvent wash, a solvent surfactant wash, or a combination thereof. In one exemplary embodiment, the two component package will consist of an aqueous film-forming automotive coating composition comprising a film-forming polymer and a solvent; and an aqueous wash removal composition that is at least one of a surfactant wash, a solvent wash, a solvent surfactant wash, or a combination thereof.

The above-described and other features will be appreciated and understood by those skilled in the art from the following detailed description, and appended claims.

### DETAILED DESCRIPTION

In one embodiment, a method of protecting an automobile exterior comprises disposing a layer of a curable automotive coating composition on at least a portion of the automobile exterior and exposing the layer to radiation to form a cured layer. The curable automotive coating composition comprises a curable acrylate monomer, oligomer, or combination thereof; a photo-polymerization initiator; and optionally a curable fluorine-containing or sulfur-containing monomer, oligomer, or combination thereof. The automotive coating composition may be applied to an automobile, cured, and optionally removed at a later time.

Suitable curable acrylate monomers and/or oligomers have two or more acrylate groups per molecule, for example, a compound having two or more acrylate groups having a double bond between the alpha and beta carbon atoms in a carbonyl group. Suitable acrylate esters of polyols include, for example, ethyleneglycol diacrylate, neopentylglycol diacrylate, trimethylolpropane triacrylate, pentaerythritol tetraacrylate, dipentaerythritol hexaacrylate, 1,4-cyclohexyldimethanol diacrylate, 4,4′-isopropiridenedicyclohexanol diacrylate, bis(hydroxymethyl) tricyclo[5,2,1,0]decanediacrylate, 1,3,5-tris (2-hydroxyethyl) cyanuric acid triacrylate and the like, and polyacrylate resins of acrylic polyols, polyacrylate resins of polyether polyols, polyacrylate resins of epoxy polyols, polyacrylate resins of polyurethane polyols, polyacrylate resins of silicone polyols and the like; and combinations comprising one or more of the foregoing acrylate esters of polyols.

Other suitable acrylate monomers and/or oligomers include unsaturated polyesters containing α,β-unsaturated dicarboxylic acid such as fumalic acid, maleic acid, and the like, and combinations comprising one or more of the foregoing unsaturated polyesters. The unsaturated polyester can be obtained by polycondensation of an acid component comprising a polyhydric carboxylic acid containing an α,β-unsaturated dicarboxylic acid such as maleic anhydride or fumalic acid with a polyol.

Yet other suitable acrylate monomers and/or oligomers also include epoxyacrylates, urethane acrylates, acrylics containing an α,β-unsaturated carbonyl group, polyether acrylates, silicone oligomers containing an acryloyl group, and the like, and combinations comprising one or more of the foregoing acrylate monomers and/or oligomers. The epoxyacrylate resin can be obtained by ring opening addition of an epoxy group of an epoxy resin in a bisphenol type, a novolac type or the like, for example, through a reaction with a methacrylic acid or acrylic acid. The above urethane acrylate resin can be obtained by an addition reaction of 2-hydroxyethyl acrylate with a polyisocyanate compound such as isophoronediisocyanate, tolylenediisocyanate, diphenylmethanediisocyanate and hexamethylenediisocyanate, or a urethane prepolymer thereof. Regarding the acrylic resins containing an α,β-unsaturated carbonyl group, an acrylic resin having an acrylate group on a side chain thereof can be obtained by reacting acrylic acid with an acrylic resin resulting from copolymerization of a glycidylacrylate. Contrary to this, an acrylic monomer containing an epoxy group such as glycidyl acrylate may be reacted with an acrylic resin containing a carboxyl group. The above polyether acrylate resin can be obtained, for example, by reacting 2-acryloyloxyethylisocyanate with a polyether having a hydroxyl group at a terminal thereof. The silicone oligomer containing an acryloyl group may be, for example, polyorganosiloxanes having 3-acryloyloxypropyl groups at both terminals thereof, and the like.

Additional suitable diacrylates include, but are not limited to, propylene glycol diacrylate, diethylene glycol diacrylate, dipropylene glycol diacrylate, triethylene glycol diacrylate, tripropylene glycol diacrylate, tertraethylene glycol diacrylate, tetrapropylene glycol diacrylate, polyethylene glycol diacrylate, polypropylene glycol diacrylate, ethoxylated bisphenol A diacrylate, bisphenol A diglycidyl ether diacrylate, resorcinol diglycidyl ether diacrylate, 1,3-propanediol diacrylate, 1,4-butanediol diacrylate, 1,5pentanediol diacrylate, 1,6-hexanediol diacrylate, cyclohexane dimethanol diacrylate, ethoxylated neopentyl glycol diacrylate, propoxylated neopentyl glycol diacrylate, ethoxylated cyclohexanedimethanol diacrylate, propoxylated cyclohexanedimethanol diacrylate, epoxy diacrylate, aryl urethane diacrylate, aliphatic urethane diacrylate, polyester diacrylate, and combinations comprising one or more of the foregoing diacrylates. Suitable diacrylates include ethoxylated (30) bisphenol A diacrylate, a 30 mole ethoxylated bisphenol A diacrylate, available as CD9038 from Sartomer; polyethylene glycol (600) diacrylate, available as SR610 from Sartomer; and combinations comprising one or more of the foregoing diacrylates.

Additional suitable triacrylates include, but are not limited to, glycerol triacrylate, ethoxylated trimethylolpropane triacrylate, propoxylated trimethylolpropane triacrylate, tris (2-hydroxyethyl) isocyanurate triacrylate, ethoxylated glycerol triacrylate, propoxylated glycerol triacrylate, pentaerythritol triacrylate, aryl urethane triacrylates, aliphatic urethane triacrylates, melamine triacrylates, epoxy novolac triacrylates, aliphatic epoxy triacrylate, polyester triacrylate, ethoxylated versions of the foregoing triacrylates, and combinations comprising one or more of the foregoing triacrylates. A suitable triacrylate is ethoxylated (20) trimethylolpropane triacrylate, a 20 mole ethoxylated trimethylolpropane triacrylate, available as SR415 from Sartomer.

Additional suitable tetraacrylates include, but are not limited to, di-trimethylolpropane tetraacrylate, pentaerythritol tetraacrylate, ethoxylated pentaerythritol tetraacrylate, propoxylated pentaerythritol tetraacrylate, dipentaerythritol tetraacrylate, ethoxylated dipentaerythritol tetraacrylate, propoxylated dipentaerythritol tetraacrylate, aryl urethane tetraacrylates, aliphatic urethane tetraacrylates, polyester tetraacrylates, melamine tetraacrylates, epoxy novolac tetraacrylates, and combinations comprising one or more of the foregoing tetraacrylates.

Combinations comprising one or more of the foregoing curable acrylate monomers and oligomers may also be employed, for example, a combination of a diacrylate monomer and a triacrylate monomer. In one embodiment, the curable acrylate oligomer comprises ethoxylated bisphenol A diacrylate; polyethylene glycol diacrylate; ethoxylated trimethylolpropane triacrylate; and combinations comprising one or more of the foregoing acrylate monomers.

The amount of the curable acrylate monomer, oligomer, or combination thereof, in the curable automotive coating composition is about 10 percent by weight (wt %) to about 99 wt % based on the total weight of the curable automotive coating composition. In another embodiment, the amount of the curable acrylate monomer, oligomer, or combination thereof, in the curable coating composition is about 40 wt % to about 80 wt % based on the total weight of the curable automotive coating composition.

The curable automotive coating composition also comprises a photo-polymerization initiator. Suitable photo-polymerization initiators for the curable automotive coating composition include, for example, benzoins and benzoin alkylethers such as benzoin, benzoin methylether, benzoin ethylether and benzoin propylether; acetphenones such as acetophenone, 2,2-dimethoxy-2-phenylacetophenone, 2,2-diethoxy-2-phenylacetophenone, 1,1-dichloroacetophenone; aminoacetophenones such as 2-methyl-1-[4-(methylthio)phenyl]-2-morpholinopropanone-1,2-benzyl-2-dimethylamino-1-(4-morpholinophenyl)-butanone-1, N,N-dimethylaminoacetophenone; anthraquinones such as 2-methylanthraquinone, 2-ethylanthraquinone, 2tert-butylanthraquinone, 1-chloroanthraquinone; thioxanthones such as 2,4dimethyl thioxanthone, 2,4-diethyl thioxanthone, 2-chloro thioxanthone and 2,4-diisopropyl thioxanthone; ketals such as acetophenone dimethylketal and benzyl methylketal; benzophenones or xanthones such as benzophenone and 4,4′-bisdiethylaminobenzophenone; 2,4,6-trimethylbenzoyldiphenylphosphine oxide; iodonium salts, sulfonium salts and diazonium salts of aromatic compounds; polysilane compounds; and combinations comprising one or more of the foregoing photo-polymerization initiators.

In one embodiment, the photo-polymerization initiator is one that can initiate photopolymerization in the presence of natural sunlight such as those photo-polymerization initiators that have absorption bands in the visible light wavelengths, at wavelengths of UV light present in natural sunlight, or a combination thereof. Such photo-polymerization initiators include, for example, benzophenone; derivatives of benzophenone; 5,7-diiodo-3-butoxy-6-fluorone, a visible-light-harvesting photo-polymerization inhibitor available as H-NU 740 from Spectra Group; and the like; and combinations comprising one or more of the foregoing photo-polymerization initiators. A suitable photo-polymerization initiator is a blend of phosphine oxide, alpha-hydroxyketone and benzophenone derivative available as SR1135 from Sartomer.

The amount of photo-polymerization initiator is not specifically limited, but set properly according to the absorbance of the initiator or

dye at the wavelengths of polymerization. The amount of the photo-polymerization initiator in the curable automotive coating composition is about 0.01 wt % to about 5 wt % based on the total weight of the curable automotive coating composition. When the photo-polymerization inhibitor comprises SR1135, the SR1135 comprises about 1 wt % to about 5 w % based on the total weight of the curable automotive composition.

The curable automotive coating composition optionally further comprises a reactive fluorine-containing or sulfur-containing monomer, oligomer, or combination thereof. In one embodiment, the reactive fluorine-containing monomer is a fluorinated polyether diol. Suitable fluorinated polyether diols may be prepared using oxetane chemistry and are commercially available from Omnova Solutions Inc. under the trade name PolyFox®, including PolyFox® 6320, 6520, 636, 656, and combinations comprising one or more of the foregoing fluorinated polyether diols. In another embodiment, the reactive fluorine-containing monomer comprises a curable fluorine-containing monomer. The curable fluorine-containing monomer and/or oligomer comprises a fluorinated compound to which at least one curable functional group is bound. Suitable curable functional groups include, for example, groups containing vinyl, acrylate, methacrylate, maleate, vinyl ether, acrylamide, and combinations comprising one or more of the foregoing functional groups. An examples of a commercially available fluorinated compound containing a curable functional group include is PolyFox® 3320, commercially available from Omnova Solutions. An example of a reactive sulfur-containing compound is Coat-O-Sil 3509® commercially available from Omnova Solutions.

The amount of the optional reactive fluorine-containing or sulfur-containing monomer, oligomer, or combination thereof in the curable automotive coating composition is about 0 wt % to about 5 wt % based on the total weight of the curable automotive coating composition. In another embodiment, the amount of the reactive fluorine-containing or sulfur-containing monomer, oligomer, or combination thereof in the curable automotive coating composition is about 0 wt % to about 3 wt % based on the total weight of the curable automotive coating composition.

The curable automotive coating composition can comprise a solvent, an additive, and the like, and combinations comprising one or more of the foregoing. Suitable solvents include, for example, water, organic solvents, and combinations thereof.

Other materials well-known to the coatings artisan, for example, surfactants, fillers, stabilizers, wetting agents, dispersing agents, adhesion promoters, UV absorbers, light stabilizers such as HALS, antioxidants, solvents, catalysts, anti-foam agents, viscosity modifiers, and/or rheology control agents, may be incorporated into the disclosed coating composition. The amount of these materials used must be controlled to achieve the desired performance properties and/or to avoid adversely affecting the coating characteristics.

The curable automotive coating composition may be packaged in an opaque package to protect the composition from ambient radiation prior to use. The protective coatings obtained from the curable automotive coating composition are especially advantageous in that they are durable and provide protection against stone chips and bug damage. In one embodiment, such films can be removed and reapplied.

In another embodiment, the disclosed method of providing short term protection to an automobile exterior will comprise applying a layer of an aqueous film-forming automotive coating composition to at least a portion of an automobile exterior; drying the aqueous film-forming automotive coating composition at ambient conditions to form a protective coating that does not substantially alter the gloss or color of the automobile exterior; and removing the protective coating after a period of time post application in a manner that does not result in damage to the automobile exterior and does produce a biodegradable waste stream.

As used herein, a film-forming automotive coating is distinguishable from the foregoing ‘curable coating compositions’ in that the former do not require the application of electromagnetic energy, to form a substantially continuous film or protective coating. It will be appreciated however, that the curing or film formation process of the disclosed aqueous film-forming coating compositions may be enhanced by exposure to natural sunlight and the like. By substantially continuous, it is meant that the coating lacks pinholes through which dirt, salt and water, for example, can penetrate. In one embodiment, the film-film forming coating will form a film via coalescence occurring as a result of drying, i.e., the evaporation of removal of solvent.

In one embodiment, the disclosed aqueous film-forming composition comprises a film-forming polymer and a solvent. In another embodiment, the disclosed aqueous film-forming compositions will further comprise one or more optional wetting agents and/or additives.

Suitable film-forming polymers include, for example, acrylic emulsion polymers such as acrylic emulsion polymers such as alkali soluble acrylic emulsion polymers, polyvinyl alcohol, acrylate resins, methylvinyl ether copolymers, polyvinyl pyrrolidone, ethyl cellulose, hydroxypropyl cellulose, methoxyhydroxypropyl cellulose, ethylene/maleic anhydride copolymer, water soluble nylon polymers, urea resins, melamine resins, block copolymers of polyethylene oxide and polypropylene oxide; and combinations comprising one or more of the foregoing polymers.

In one embodiment, the aqueous film-forming composition will comprise an acrylic emulsion polymer. In one exemplary embodiment, the aqueous film-forming composition will comprise an alkali soluble acrylic emulsion polymer.

An “alkali-soluble” acrylic emulsion polymer is an acrylic emulsion polymer at least a portion or stage thereof having a solubility in an alkaline environment, generally at pH of 6.5 and higher, which exceeds the solubility of the polymer in acidic environments. It will be appreciated that in one exemplary embodiment, such polymers are acid functional prior to incorporation into a solution having an alkaline pH. Alkali-soluble acrylic emulsion polymers in one embodiment comprise acid functional acrylic emulsion polymers wherein at least a portion of the acid groups have been neutralized with a basic compound. In one exemplary embodiment, substantially all of the acid groups have been neutralized by basic compound such as an amine or hydroxyl functional compound.

Illustrative acrylic emulsion polymers include polymers and copolymers of nonfunctional monomers, functional monomers, and polyacrylate functional monomers.

In one embodiment, nonfunctional monomers may refer to alkyl esters of acrylic acid and methacrylic acid and other vinyl group containing monomers such as styrene, and mixtures of such nonfunctional monomers. With regards to alkyl acrylate esters, the alkyl portion may have from one to eighteen carbon atoms and may be aliphatic, cycloaliphatic or aryl. Illustrative examples of suitable alkyl acrylate esters include methyl acrylate, methyl methacrylate, ethyl acrylate, ethyl methacrylate, propyl acrylate, propyl methacrylate, butyl acrylate, butyl methacrylate, similar monomers, and combinations comprising one or more of the foregoing monomers.

As used herein, the term “alkyl” includes both branched and straight chain saturated aliphatic hydrocarbon groups, having the specified number of carbon atoms. The term C₁-C₇ alkyl as used herein indicates an alkyl group having from 1 to about 7 carbon atoms. When C₀-Cₙ alkyl is used herein in conjunction with another group, for example, heterocycloalkyl (C₀-C₂ alkyl), the indicated group, in this case heterocycloalkyl, is either directly bound by a single covalent bond (C₀), or attached by an alkyl chain having the specified number of carbon atoms, in this case from 1 to about 2 carbon atoms. Examples of alkyl include, but are not limited to, methyl, ethyl, n-propyl, isopropyl, n-butyl, 3-methylbutyl, t-butyl, n-pentyl, and sec-pentyl.

The term ‘functional monomer’ refers to monomers having at least one acrylic group and at least one other functional group. Suitable functional groups are those groups that provide sites for crosslinking, compatibility, solubility, and/or the like. Illustrative examples of the at least one functional group include epoxy, allylic, hydroxyl, ether, furan, amino, acid and combinations comprising one of the foregoing. In one embodiment, the at least one functional group will be an acid group.

Suitable polyacrylate functional monomers are those monomers having more than one acrylate group, especially di- and tri-acrylate monomers.

In one exemplary embodiment, the alkali-soluble acrylic emulsion polymer comprises the polymerization product of styrene, and alkyl esters of acrylic acid and methacrylic acid.

Illustrative commercially available examples of suitable alkali soluble acrylic emulsion polymers include Joncryl 537 (S.C. Johnson), a carboxyl-containing styrene/acrylic copolymer emulsion (acrylic part is a mixture of acrylate and methacrylate esters), Joncryl 1984 (S.C. Johnson), AcryGen 9158 and CDP 3158-28 from Omnova Solutions, NeoCAR 820, NeoCAR 850, and the like. In one exemplary embodiment, the alkali soluble acrylic emulsion polymer will be Joncryl 1984.

In another embodiment, the film-forming polymer comprises a polyvinyl alcohol. The polyvinyl alcohol may be fully hydrolyzed (about 99 to about 100 mole % hydrolysis of acetate groups), intermediate hydrolyzed (about 89 to about 98 mole % hydrolysis of acetate groups), partially hydrolyzed (about 85 to about 88 weight % hydrolysis), or a mixture thereof. The average molecular weight of the polyvinyl alcohol may be about 15,000 to about 100,000. In one embodiment, the polyvinyl alcohol is a fully hydrolyzed polyvinyl alcohol.

The film-forming polymer comprises about 1 wt % to about 30 wt % of the total weight of the film-forming automotive composition. In another embodiment, the film-forming polymer comprises about 5 wt % to about 15 wt % of the total weight of the film-forming automotive composition. In yet another embodiment, the film-forming polymer comprises about 6 wt % to about 10 wt % of the total weight of the aqueous film-forming automotive composition.

The aqueous film-forming automotive composition optionally comprises a wetting agent. In one exemplary embodiment, the aqueous film-forming automotive composition will comprises at least one wetting agent.

Wetting agents include materials that aid the ability of water to spread or “wet” a surface. Wetting agents include, but are not limited to, surfactants, defoamers, phosphates, silicone fluids, coupling agents, phosphonates, sulfates, sulfonates, fatty acids, fluoro-compounds, silicon containing compounds and their derivatives, and combinations comprising one or more of the foregoing wetting agents. Surfactant wetting agents include non-ionic, cationic, anionic, amphoteric and zwitterionic surfactants.

Specific wetting agents that may be employed include, but are not limited to, silicone-based wetting agents available as Dow Corning® Additives 28, 55, 57, 67, and HV490, for example; the fluorosurfactants commercially available under the trade name Fluorad® from the 3M Company including Fluorad® FC-4430 and Fluorad® FC-4432; the fluoropolymers commercially available under the trade name Zonyl® from E.I. du Pont de Nemours and Company including Zonyl® FSH, Zonyl® FSN, Zonyl® FSO, and Zonyl® FSP; the polysiloxane surfactants available under the trade name CoatOSil® from Crompton Corporation, including CoatOSil® 1211, CoatOSil® 1301, and CoatOSil® 200; the silicone surfactants available from BYK Chemie including BYK®-347 and BYK®-348; the polyether siloxane copolymers available from Tego Chemie as TEGO® Wet 260, TEGO® Wet 270, TEGO® Wet 280, and TEGO® Wet KL 245; and alkyl polyglycosides such as Simulsol 71-30 commercially available from Seppic. Combinations of wetting agents such as, for example, a combination of a silicone-based wetting agent and a fluorosurfactant may be employed in one exemplary embodiment.

Suitable wetting agents also include, for example, polyalkylene oxide polysiloxanes. In general, the polyalkylene oxide polysiloxanes have a dimethyl polysiloxane hydrophobic moiety and one or more hydrophilic polyalkylene chains. The hydrophilic polyakylene chains can be incorporated as side chains (pendant moieties) or as block copolymer moieties with the polysiloxane hydrophobic moiety. Polyalkylene oxide polysiloxanes may be described by the following general formulas IV and V:
R⁹(CH₃)₂SiO—[(CH₃)₂SiO]ₐ—[(CH₃)(R⁹)SiO]_{b}Si(CH₃)₂—R⁹ (IV)
wherein a+b are about 1 to about 50, or about 1 to about 30, or about 1 to about 25, and each R⁹ is the same or different and is a methyl or a poly(ethyleneoxide/propyleneoxide) copolymer group having the general formula:
—(CH₂)ₙO(C₂H₄O)_{c}(c₃H₆O)_{d}R¹⁰ (V)
wherein at least one R⁹ is a poly(ethyleneoxy/propyleneoxy) copolymer group, and wherein n is 3 or 4; c (for all polyalkyleneoxy side groups) has a value of 1 to about 100, or about 6 to about 100; c+d has a value of about 5 to about 150, or about 7 to about 100; and each R¹⁰ is the same or different and is hydrogen, a C₁-C₄ alkyl, or an acetyl group. Each polyalkylene oxide polysiloxane has at least one R⁹ group being a poly(ethyleneoxide/propyleneoxide) copolymer group.

Examples of these type of silicone compounds are the Silwet® surfactants which are available from Crompton. Representative Silwet® surfactants which contain only ethyleneoxy (C₂H₄O) groups include L-7608, L-7607, L-77, L-7605, L-7604, L-7600, L-7657, L-7602, L-7622, L-8600, L-8610, and L-8620.

Examples of Silwet® surfactants which contain both ethyleneoxy (C₂H₄O) and propyleneoxy (C₃H₆O) groups include L-720, L-7001, L-7002, L-7210, L-7200, and L-7220.

Examples of Silwet® surfactants which contain only propyleneoxy (C₃H₆O) groups include L7500, L7510, L7550, and L8500.

The molecular weight of the polyalkyleneoxy group (R⁹) may be less than or equal to about 10,000. The suitable molecular weight of the polyalkylene oxide polysiloxane is dependent on the exact functionality in a given composition. If propyleneoxy groups are present in the polyalkylenoxy chain, they can be distributed randomly in the chain, or exist as blocks. Other nonlimiting examples of polyalkylene oxide polysiloxanes include the following compounds available from Dow Corning® 193, 190, FF-400 Fluid, Q2-5220, Q4-3667, Q2-5211, as well as compounds available from Toray Dow Corning Silicone Co., Ltd. know as SH3771C, SH3772C, SH3773C, SH3746, SH3748, SH3749, SH8400, SF8410, and SH8700, KF351 (A), KF352 (A), KF354 (A), and KF615 (A) of Shin-Etsu Chemical Co., Ltd., TSF4440, TSF4445, TSF4446, TSF4452 of Toshiba Silicone Co.

When present, the wetting agent comprises about 0.001 wt % to about 3 wt % of the total weight of the film-forming automotive composition. In another embodiment, the wetting agent comprises about 0.01 wt % to about 2 wt % of the total weight of the film-forming automotive composition. In yet another embodiment, the wetting agent comprises about 0.1 wt % to about 1.0 wt % of the total weight of the film-forming automotive composition.

The aqueous film-forming automotive coating composition also comprises a solvent. In one embodiment, illustrative examples of suitable solvents are water, alcohols, alkylene glycol ethers such as propylene glycol n-butyl ether and dipropylene glycol n-butyl ether, butyl cellosolve, butyl carbitol, and the like as well as combinations comprising one or more of the foregoing solvents. Suitable alcohols include, for example, ethanol, isopropanol, methanol, and combinations comprising one or more of the foregoing alcohols. In one exemplary embodiment, the solvent will comprise water. In another exemplary embodiment, the solvent will comprise water and at least one other solvent. In one embodiment, the at least one other solvent will comprise an alkylene glycol ether.

The terms ‘aqueous film-forming automotive coating composition’, ‘aqueous film-forming coating composition’, and ‘aqueous film-forming composition’ as used herein refers to compositions having at least 5% by weight of water, based on the total weight of the composition. In one embodiment, such compositions may have from 5 to 50% by weight of water, based on the total weight of the composition. In another embodiment, such compositions may have from 8 to 35% by weight of water, based on the total weight of the composition. In another embodiment, such compositions may have from 10 to 25% by weight of water, based on the total weight of the composition.

The aqueous film-forming automotive coating composition may optionally further comprise a water-repellent agent. Examples of the water-repellent agent are organic silicon compounds such as hydrolysates of trimethylmethoxysilane, dimethyldimethoxysilane, trimethylethoxysilane, dimethyldiethoxysilane, diethyldiethoxysilane and diethyldimethoxysilane; fluororesins such as polytetrafluoroethylene, polytrichlorofluoroethylene, polyvinylidenefluoride, polyvinylfluoride, copolymers of tetrafluoroethylene and hexafluoropropylene, and copolymers of tetrafluoroethylene and ethylene; mixtures of the organic silicon compounds and the fluororesins; and silane compounds containing a fluorocarbon group, such as CF₃CH₂CH₂Si(OCH₃)₃, CF₃(CF₂)₅CH₂CH₂Si(OCH₃)₃, CF₃(CF₂)₇CH₂CH₂Si(OCH₃)₃, CF₃(CF₂)₇CH₂CH₂CH₃Si(OCH₃)₂, CF₃(CF₂)₇CH₂CH₂SiCl₃ or a partial hydrolysate of these silane compounds; and combinations comprising one or more of the foregoing water-repellent agents.

In one embodiment, the film-forming polymer will be self-crosslinking. Illustrative examples of self-crosslinking polymers include Viacryl VSC 6295w 45WA, from Cytec, NeoCAR 850, NeoCAR 6424, and NeoCAR 7658 from Dow Chemical, Joncryl 1984 from Johnson Polymer and Armorez IC-3000 from Mead Westvaco.

In another embodiment, the aqueous film-forming automotive coating composition may optionally further comprise a crosslinking agent. Suitable crosslinking agents include, for example, a benzetriol, an isocyanate, a dialdehyde, a stryrene-maleic copolymer, an aldehyde, a polyhydric alcohol, a polyvalent epoxy compound, a polyvalent glycidyl compound, a polyvalent azilidine compound, a polyvalent amine compound, a polyvalent isocyanate compound, a glyoxal, a polyvalent metal salt, a silane coupling agent, an alkylene carbonate, titanates, and the like, and combinations comprising one or more of the foregoing crosslinking agents.

Exemplary crosslinking agents include Tyzor® LA, a hydrolytically stable lactic acid chelate available from DuPont; Silquest A-link 25, an amino-functional silane coupling agent commercially available from OSI Specialties; and glyoxal, commercially available from BASF.

The aqueous film-forming automotive coating composition may optionally further comprise a biocide. A suitable biocide is Proxel GXL, a mixture of 1,2-benzisothiazolin-3-one (BIT), sodium hydroxide, and dipropylene glycol available from Avecia Inc.

One or more other additives may also be incorporated into the disclosed aqueous film-forming compositions. Illustrative additives, include, for example, surfactants, fillers, stabilizers, dispersing agents, adhesion promoters, UV absorbers, light stabilizers such as HALS, antioxidants, catalysts, anti-foam agents, viscosity modifiers, scratch and mar additives, and/or rheology control agents, may be incorporated into the disclosed coating composition. The amount of these materials used must be controlled to achieve the desired performance properties and/or to avoid adversely affecting the coating characteristics.

The film-forming automotive additive composition may, for example, be formed by simply admixing the components to form a mixture such as a substantially homogeneous mixture.

The curable automotive coating composition or aqueous film-forming automotive coating composition is applied to a portion of an automobile exterior to form a layer.

The term ‘automotive exterior’ as used herein refers to any exterior surface of a vehicle having at least two wheels moved by a power source such as an internal combustion engine, electric motors, fuel cells, and the like, as well as combinations thereof. Exterior surfaces include coated surfaces, glass surfaces, metal surfaces, plastic surfaces, and combinations thereof. However, in one exemplary embodiment, an automotive exterior will be a cured coated surface of an automobile, such as a paint surface. Such painted surfaces may be OEM (original equipment manufacturers) finishes or refinish coatings.

The curable automotive coating composition or aqueous film-forming automotive coating composition is applied by one of a variety of techniques known for the application of paint, including, but not limited to, application by brush, foam brush, pad, sponge, aerosol roller, spray, dipping, spreading (e.g. using a doctor bar), and the like, and combinations comprising one or more of the foregoing application techniques. In one exemplary embodiment, the disclosed compositions will be applied by foam brush.

The curable automotive coating composition or aqueous film-forming automotive coating composition may be applied at a thickness of about 0.5 mil to about 200 mil (about 0.012 mm to about 5.1 mm), although other thicknesses may be employed.

In the case of a curable automotive coating composition, once the film is formed, the film is cured using light. The wavelength of light used to initiate photo-polymerization depends upon the photo-polymerization initiator employed. Suitable light sources include natural sunlight; carbon arc lamps; xenon arc lamps; medium-pressure, high-pressure and low-pressure mercury lamps optionally doped with metal halides (metal halogen lamps); microwave-stimulated metal vapor lamps; excimer lamps; superactinic fluorescent tubes; fluorescent lamps; incandescent argon lamps; flashlights; photographic floodlight lamps light-emitting diodes (LED), electron beams, X-rays, and combinations comprising one or more of the foregoing light sources. The distance between the light source and the substrate to be exposed can vary depending on the intended use and lamp type and intensity. In one embodiment, the light source is natural sunlight.

In the case of a aqueous film-forming automotive coating composition, the composition is dried under ambient conditions. Ambient conditions as used herein refers to ambient temperatures such as are normally encountered outdoors in the continental United States during the seasons of spring, fall, and winter. In one embodiment, the composition will be dried at a minimum ambient temperature of 50° F. In one exemplary embodiment, the application and drying temperatures will be the same.

Drying can take a period of from 1 to 20 minutes for a tacky surface to 10 to 30 minutes for a touchable, tack free surface.

It will be appreciated that drying the aqueous film-forming automotive coating composition at ambient conditions results in a protective coating that does not substantially lower the gloss of the automobile exterior. The phrase ‘substantially lower the gloss’ refers to a change in gloss such that a reasonable person could perceive a difference with the naked eye between an automotive exterior coated with the disclosed protective coating and one that is not. Of course in one exemplary embodiment, the application of the disclosed coating compositions will result in an increased shine or gloss. That is, the application of the protective coating will improve or enhance the aesthetic appearance of the automotive exterior. In another embodiment, the protective coating will not change the perceived color of the automotive exterior.

It is an aspect of the disclosed method that the protective coating will be removed after a period of time post application in a manner that does not result in damage to the automobile exterior and does produce a biodegradable waste stream.

In general, the coating may be removed at any time after application. In one embodiment, the protective coating will be removed anywhere from several days to several months or more after application. In another embodiment, the protective coating will be removed six to twelve months after application. In one exemplary embodiment, the protective coating will be removed three to nine months after application.

The removal of the protective coating must be done without damage to the underlying automotive exterior surface. Damage to the underlying automotive exterior includes, but is not limited to scratches, loss of gloss, hazing, blushing, loss of DOI, fading of color or metallic effects, dullness, and the like.

After a period of time, at least a portion of the layer may optionally be removed from the automobile exterior. The layer may be removed, for example, by stripping, peeling, washing or the like. In one exemplary embodiment, the protective coating will be removed as a result of contact with a wash removal composition.

The wash removal compositions will be provided in two forms, a concentrated packaged component and a diluted, ready to use composition. It will be appreciated the former is part of a two-component package intended for sale to an end user. The user will dilute the concentrate with water, especially dionized water, to obtain a diluted ready to use wash removal composition. Thus, the concentrate will have a % wt of water of no more than 30%, based on the total weight of the concentrate. In one embodiment, the concentrate will have from 0.1 to 15% wt of water, based on the total weight of the concentrate. In another embodiment, the concentrate will have from 0.1 to no more than 10% wt of water, based on the total weight of the concentrate. In one exemplary embodiment, the concentrate will have from 0.1 to no more than 1.5% wt of water, based on the total weight of the concentrate.

The concentrated wash removal concentrates will in all embodiments be diluted to provide the wt % of water discussed below.

In one embodiment, the wash removal composition is left in contact with the protective coating for a period of time such that the action of the wash removal composition disrupts and interferes with the adhesive forces between the protective coating and the automotive exterior. In one embodiment, the wash removal composition will be placed in contact with the protective coating for a period of time from several seconds to 20 minutes. In another embodiment, the wash removal composition will be placed in contact with the protective coating for a period of time from 2 to 7 minutes.

The disruption of the adhesive forces between the protective coating and the automotive exterior is such that in one exemplary embodiment, the protective coating and wash removal composition will be removed from the automotive exterior by simple mechanical wiping such as done by the human hand with a sponge or towel.

It is an aspect of the disclosed method that the removal process produces a biodegradable waste stream. The term ‘biodegradable’ as used herein refers to a waster stream that can be flushed down the home drains or sewers of consumers.

In one embodiment, the wash removal composition will comprise a surfactant and water, optionally at an alkaline pH (i.e., a pH of greater than 7). Suitable alkaline wash solutions may comprise, for example, solutions of ammonia, sodium carbonate, potassium carbonate, ethanol amines, and the like, and combinations comprising one or more of the foregoing components, in water.

In another embodiment, the aqueous wash removal composition is at least one of a surfactant wash, a solvent wash, a solvent surfactant wash, or a combination thereof.

A surfactant wash refers to a wash removal composition that comprises a surfactant and water. Suitable surfactants are those that work in an alkaline environment, i.e., alkaline stable. Illustrative examples of suitable commercially available surfactants include Tomakleen TFR surfactant from Tomah, Tomah's Alkali Surfactant MN, TRITON™ CF-10, TRITON CF-21, TRITON CF-76, and TRITON DF-20, all from Dow Chemical, and Amphoteric 400, Amphoteric LH, Amphoteric TC, and Albemarle Corp's Admox 8, 10, and 12

In one embodiment, the surfactant will present in an amount of from 0.1 to 50% by weight, based on the total weight of the wash removal composition. In another embodiment, the surfactant will present in an amount of from 1.0 to 30% by weight based on the total weight of the wash removal composition. In one embodiment, water will be present in an amount of from 30 to 99% by weight, based on the total weight of the wash removal composition, while in another embodiment, water will be present in an amount of from 50 to 95% by weight,

In another embodiment, the surfactant wash may further comprise buffering agents such as monosodium phosphate, trisodium phosphate, and the like, as well as combinations thereof. Such washes may be referred to as buffered surfactant washes.

In another embodiment, the surfactant wash may further comprise alkaline compounds such as amines and hydroxyl compounds. Illustrative examples include isopropanolamine and ammonium hydroxide. Such washes may be referred to as surfactant amine washes.

In another embodiment, the aqueous wash removal composition will be a solvent wash that does not contain a surfactant and comprises one or more solvents. as discussed above. In one exemplary embodiment, the solvents used in the solvent wash will be at least one of water, butyl carbitol, butyl cellosolve, alkylene glycol ethers such as propylene glycol n-butyl ether and dipropylene glycol n-butyl ether, and combinations thereof.

In one embodiment, water will be present in the solvent wash in an amount of from 30 to 99.9% by weight, based on the total weight of the wash removal composition, while in another embodiment, water will be present in an amount of from 75 to 98% by weight.

Auxiliary compounds such as d-limoneen may also be added to the solvent wash in amounts of from 0.1 to 10% by weight, or from 1 to 5% by weight, based on the total weight of the solvent wash.

In another embodiment, the aqueous wash removal composition will be a solvent surfactant wash that is a combination of the foregoing surfactant wash and solvent wash as discussed above. In one exemplary embodiment, of the disclosed method, the aqueous wash removal composition will be a solvent surfactant wash.

Also disclosed herein is a two-component package for use in the disclosed method of providing short-term protection to an automobile exterior. Such packages will be directed toward consumers in order to facilitate ease of application and removal. In one embodiment, the package comprises an aqueous film-forming automotive coating composition comprising a film-forming polymer and a solvent; and an aqueous wash removal composition that is at least one of a surfactant wash, a solvent wash, a solvent surfactant wash, or a combination thereof. In one exemplary embodiment, the package will consist of an aqueous film-forming automotive coating composition comprising a film-forming polymer and a solvent; and an aqueous wash removal composition that is at least one of a surfactant wash, a solvent wash, a solvent surfactant wash, or a combination thereof.

The invention is further illustrated by the following non-limiting examples.

### EXAMPLES 1-3

### Curable Acrylate Compositions

Curable automotive coating compositions were mixed according to the amounts shown in Table 1. Films were made by spreading the coating compositions onto automotive panels followed by curing in sunlight.

TABLE 1

| | Example | | |
|---|---|---|---|
| | 1 | 2 | 3 |
| CD 9038 ethoxylated (30) bisphenol A | 80 wt % | 40 wt % | 40 wt % |
| diacrylate | | | |
| SR610 polyethylene glycol (600) | — | 40 wt % | — |
| diacrylate | | | |
| SR415 ethoxylated (20) | — | — | 40 wt % |
| trimethylolpropane triacrylate | | | |
| SR1135 photo-polymerization initiator: | 3 wt % | 3 wt % | 3 wt % |
| phosphine oxide, alpha-hydroxyketone | | | |
| and benzophenone derivative | | | |
| Water | 17 wt % | 17 wt % | 17 wt % |
| Properties | Films | Films do | Films do |
| | crack | not crack | not crack |

The films formed according to Examples 2 and 3 did not crack easily and were removed via loosening with soapy water followed by peeling of the layer.

### EXAMPLES 4-10

### Film-Forming Resin Compositions

Film-forming resin compositions were formed according to Table 2. The balance of the formulations was water in all cases.

TABLE 2

| | Example | | | | | | | | | | | | | |
|---|---|---|---|---|---|---|---|---|---|---|---|---|---|---|
| | 4 | | 5 | | 6 | | 7 | | 8 | | 9 | | 10 | |
| Polyvinyl alcohol: | 5 | wt % | 5 | wt % | 5 | wt % | 5 | wt % | 5 | wt % | 7 | wt % | 5 | wt % |
| Elvanol 71-30 | | | | | | | | | | | | | | |
| Wetting agent: Dow | 0.1 | wt % | | | | | | | | | | | | |
| Corning 28 | | | | | | | | | | | | | | |
| Wetting agent: | | | 0.1 | wt % | | | | | | | | | | |
| CoatOSil 2400 | | | | | | | | | | | | | | |
| Wetting agent: BYK- | | | | | 0.1 | wt % | | | | | | | | |
| 348 | | | | | | | | | | | | | | |
| Wetting agent: TEGO | | | | | | | 0.1 | wt % | | | | | | |
| Wet 260 | | | | | | | | | | | | | | |
| Wetting agent: Silwet | | | | | | | | | 0.1 | wt % | | | | |
| L-77 | | | | | | | | | | | | | | |
| Wetting agent: | | | | | | | | | | | 0.1 | wt % | | |
| Tomdol 91-6 | | | | | | | | | | | | | | |
| Wetting agent: Zonyl | | | | | | | | | | | 0.1 | wt % | 0.1 | wt % |
| FSH | | | | | | | | | | | | | | |
| Wetting agent: | | | | | | | | | | | | | 0.1 | wt % |
| Simulsol SL 11 W | | | | | | | | | | | | | | |
| Biocide: Proxel GXL | 0.05 | wt % | | | | | 0.05 | wt % | 0.05 | wt % | 0.05 | wt % | 0.05 | wt % |

The aqueous film-forming compositions were applied to a clean 6″×12″ clear coated painted metal panels using a 1 inch foam poly-brush. The coating was observed for wetting, flow, and clarity. The formulations of Examples 4-10 all produced coatings having acceptable wetting, flow and clarity.

### EXAMPLES 11-13

### Additional Film-Forming Resin Compositions

Film-forming resin compositions were formed according to Table 3. In these examples, no wetting agents were added to the formulations. Films were made by spreading the coating compositions onto automotive panels and drying under ambient conditions.

TABLE 3

| | Example | | |
|---|---|---|---|
| | 11 | 12 | 13 |
| Acrygen 9158 | 20 wt % | 20 wt % | 40 wt % |
| water | — | 80 wt % | — |
| methanol | 80 wt % | — | 60 wt % |

The formulations of examples 11-13 all produced a good film that did not wash off with water alone.

### EXAMPLES 14-17

### Application and Removal of a Protective Coating According to the Disclosed Method

Four protective coatings (i.e, A, B, C, and D) were prepared according to Tables 4-7. The aqueous film forming coating compositions were applied with a foam brush to ACT 6×12×032 inch panels of cold rolled steel (B952 p60 DIW: unpolished) that had been coated with an automotive exterior paint system, i.e., electrocoat (U32AD400), primer (764204), basecoat (542AB921 Black), and clearcoat (RK8010). The applied coatings were allowed to dry for 48 hours. Four different aqueous wash compositions (E-H) were prepared as indicated in Table 8. After the formation of a protective coating, a drop of the identified aqueous wash removal composition was applied to a proctective coating as indicated in Table 9. For each example, the drop was left to soak for 5 minutes. In each case, the protective coating and wash composition were immediately removed with a kimwipe at the end of the 5 minute soaking period. Each test was run in triplicate.

TABLE 4
Preparation of Protective Coating A

| | Component | |
|---|---|---|
| Component Name | Type | % wt. |
| NeoCAR Acrylic 850 | Emulsion | 68.0000 |
| | Acrylic polymer | |
| DI H₂O | | 24.2000 |
| Troysol LAC | | 0.0500 |
| Zonyl FSH | Wetting agent | 0.1000 |
| Dow Corning 62 Additive | Wetting agent | 0.1000 |
| Tafigel PUR 41 | | 0.6000 |
| Arcosolv DPnB | solvent | 6.2000 |
| Plasthall BBP | solvent | 0.7500 |
| | Total: | 100.0000 |

TABLE 5
Preparation of Protective Coating B

| Formula: | Component | |
|---|---|---|
| Chemical | Type | % wt. |
| CDP 3158-28 lot 3161-199 (43.1%) | Polymer | 70.0000 |
| DI H₂O | | 21.1500 |
| Tego 1495 | | 0.2000 |
| Dowanol PnB | solvent | 3.0000 |
| Dynol 604 | | 0.1000 |
| Zonyl FSP | Wetting agent | 0.1000 |
| Proxel GXL | biocide | 0.0500 |
| Dowanol DPnB | solvent | 4.3000 |
| Eastman DBP | solvent | 0.7000 |
| Tafigel PUR 41 | | 0.4000 |
| | Total: | 100.0000 |

TABLE 6
Preparation of Protective Coating C

| Formula: | Component | |
|---|---|---|
| Chemical | Type | % wt. |
| NeoCAR Acrylic 820 | Acrylic | 80.0000 |
| | polymer | |
| Zonyl 8867L | Wetting agent | 1.0000 |
| DI H₂O | | 12.3500 |
| TEGO Airex 902W | | 0.1000 |
| BYK-1660 | surfactant | 0.2000 |
| UCAR Polyphobe TR-117 | | 0.5000 |
| NH₄OH (29%) | | 0.2500 |
| BYK-346 | surfactant | 0.1000 |
| Butyl Carbitol | solvent | 2.0000 |
| Dowanol DPM | solvent | 1.0000 |
| Butyl Cellosolve | solvent | 2.5000 |
| | Total: | 100.0000 |

TABLE 7
Preparation of Protective Coating D

| Formula: | Component | |
|---|---|---|
| Chemical | Type | % wt. |
| Joncryl 1984 | Acrylic | 73.1800 |
| | emulsion | |
| | polymer | |
| DI H₂O | | 12.9700 |
| BYK-024 | surfactant | 0.2000 |
| Butyl Cellosolve | solvent | 2.0000 |
| Dynol 604 | | 0.10000 |
| Zonyl FSP | Wetting agent | 0.1000 |
| Proxel GXL | biocide | 0.0500 |
| Jonwax 26 | | 2.5000 |
| Arcosolv DPnB | solvent | 7.0000 |
| Plasthall BBP | | 0.9000 |
| Tafigel PUR 41 | | 1.0000 |
| | Total: | 100.0000 |

TABLE 8
Preparation of Aqueous Wash Removal Compositions E, F, G, and H.

| Component | E | F | G | H |
|---|---|---|---|---|
| Monosodium | 16 | — | — | — |
| phosphate | | | | |
| Trisodium | 3 | — | — | — |
| phosphate | | | | |
| Tomakleen TFR | 28.5 | 3 | — | — |
| surfactant | | | | |
| Water | 52.5 | 94 | 95 | 94.3 |
| Ammonium | — | 1 | — | 0.2 |
| hydroxide (29%) | | | | |
| Isopropanolamine | — | 2 | — | — |
| Butyl carbitol | — | — | 1 | — |
| D-limoneen | — | — | 4 | — |
| Butyl cellosolve | — | — | — | 1 |
| Arcosolve PnB | — | — | — | 2 |
| Arcosolve DPnB | — | — | — | 2 |
| Alkali surfactant | — | — | — | 0.5 |
| MN | | | | |

TABLE 9
Removal of protective coating per the disclosed method.

| | Example | | | |
|---|---|---|---|---|
| Experiment # | 14 | Example 15 | Example 16 | Example 17 |
| Film-forming | A | B | C | D |
| composition | | | | |
| Wash Removal | E | F | G | H |
| Composition | | | | |
| Result | Coating & | Coating & | Coating & | Coating & |
| | Wash | Wash | Wash removed | Wash removed |
| | removed | removed | with kimiwipe | with kimiwipe |
| | with | with | after 5 minutes | after 5 minutes |
| | kimiwipe | kimiwipe | | |
| | after 5 | after 5 | | |
| | minutes | minutes | | |

Methods of coating automobiles to protect the exterior finish are described. An advantage of the curable coating composition is that it can be applied by consumers and cured using natural sunlight. An advantage of the aqueous film-forming coating composition is that a continuous clear coating composition can be achieved. Both coating compositions can be removed by the consumer when desired.

As used herein, “alkyl” is intended to include both branched and straight-chain saturated aliphatic hydrocarbon groups, having the specified number of carbon atoms. Thus, the term C₁ to C₆ alkyl as used herein includes alkyl groups having 1 to 6 carbon atoms. When C₀ to Cₙ alkyl is used herein in conjunction with another group, for example, (phenyl)C₀ to C₄ alkyl, the indicated group, in this case phenyl, is either directly bound by a single covalent bond (C₀), or attached by an alkyl chain having the specified number of carbon atoms, in this case from 1 to about 4 carbon atoms. Examples of alkyl include, but are not limited to, methyl, ethyl, n-propyl, isopropyl, n-butyl, t-butyl, n-pentyl, and sec-pentyl.

All ranges disclosed herein are inclusive and combinable. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. “Optional” or “optionally” means that the subsequently described event or circumstance may or may not occur, and that the description includes instances where the event occurs and instances where it does not. The modifier “about” used in connection with a quantity is inclusive of the stated value and has the meaning dictated by the context (e.g., includes the degree of error associated with measurement of the particular quantity).

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

What is claimed is:

1. A method of protecting an automobile exterior comprising:
disposing a layer of a curable automotive coating composition on at least a portion of the automobile exterior, the curable automotive coating composition comprising a curable acrylate monomer, oligomer, or a combination thereof; a photo-polymerization initiator; and optionally a reactive fluorine-containing or sulfur-containing monomer, oligomer, or combination thereof; and
exposing the layer to natural sunlight to form a cured layer.

2. The method of claim 1, further comprising removing the cured layer after a period of time post-curing.

3. The method of claim 2, wherein removing comprises contacting at least a portion of the layer with soapy water followed by stripping at least a portion of the cured layer from the automobile exterior.

4. The method of claim 1, wherein the curable acrylate monomer, oligomer, or combination thereof, is an acrylate ester of a polyol, a polyacrylate resin of an acrylic polyol, a polyacrylate resin of a polyether polyol, a polyacrylate resin of an epoxy polyol, a polyacrylate resin of a polyurethane polyol, a polyacrylate resin of a silicone polyol, an unsaturated polyester containing an α,β-unsaturated dicarboxylic acid, an epoxyacrylate, a urethane acrylate, an acrylic containing an α,β-unsaturated carbonyl group, a polyether acrylate, a silicone oligomer containing an acryloyl group, or a combination comprising one or more of the foregoing acrylates.

5. The method of claim 4, wherein the curable acrylate monomer, oligomer, or combination thereof, is an ethoxylated bisphenol A diacrylate, a polyethylene glycol diacrylate, an ethoxylated trimethylolpropane triacrylate, or a combination comprising one or more of the foregoing acrylates.

6. The method of claim 1, wherein the photo-polymerization initiator has absorption bands at visible light wavelengths, at UV light wavelengths present in natural sunlight, or a combination thereof.

7. The method of claim 6, wherein the photo-polymerization initiator is benzophenone; a derivative of benzophenone; 5,7-diiodo-3-butoxy-6-fluorone; or a combination comprising one or more of the foregoing photo-polymerization initiators.

8. The method of claim 1, wherein the reactive fluorine-containing monomer comprises a fluorinated polyether diol.

9. A method of providing short term protection to an automobile exterior, the method comprising:
applying a layer of an aqueous film-forming automotive coating composition to at least a portion of an automobile exterior, the aqueous film-forming automotive coating composition comprising a film-forming polymer and a solvent;
drying the aqueous film-forming automotive coating composition at ambient conditions to form a protective coating that does not substantially alter the gloss or color of the automobile exterior; and
removing the protective coating after a period of time post application in a manner that does not result in damage to the automobile exterior and produces a biodegradable waste stream.

10. The method of claim 9, wherein removing comprises
contacting at least a portion of the protective coating with an aqueous wash removal composition for a period of time sufficient to disrupt adhesion between the protective coating and the automotive exterior, and
wiping off the aqueous wash removal composition and protective coating from the automotive exterior.

11. The method of claim 10 wherein the aqueous wash removal composition is at least one of a surfactant wash, a solvent wash, a solvent surfactant wash, or a combination thereof.

12. The method of claim 11 wherein the surfactant wash is at least one of a buffered surfactant wash or a surfactant amine wash.

13. The method of claim 12 wherein the aqueous wash removal composition comprises a solvent surfactant amine wash.

14. The method of claim 9, wherein the film-forming polymer comprises an alkali soluble acrylic emulsion polymer.

15. The method of claim 14, wherein the alkali soluble acrylic emulsion polymer comprises an acid functional styrene/acrylic emulsion polymer.

16. The method of claim 15 wherein the alkali soluble acrylic emulsion polymer is fully neutralized in the aqueous film-forming coating composition.

17. The method of claim 14 wherein the alkali soluble acrylic emulsion polymer is self-crosslinking.

18. The method of claim 9, wherein the aqueous film-forming coating composition further comprises a crosslinking agent.

19. The method of claim 18, wherein the cross-linking agent is at least one of a benzetriol, a titanate, an isocyanate, a dialdehyde, a stryrene-maleic copolymer, or a combination comprising one or more of the foregoing crosslinking agents.

20. The method of claim 9, wherein the aqueous film-forming automotive coating composition further comprises a wetting agent that is at least one of a silicone-based wetting agent, a fluorosurfactant, a polysiloxane surfactant, a silicone surfactant, a polyether siloxane copolymer, a polyalkylene oxide polysiloxane, or a combination comprising one or more of the foregoing wetting agents.

21. A two component package for use in a method of providing short term protection to an automobile exterior, the package comprising
an aqueous film-forming automotive coating composition comprising a film-forming polymer and a solvent; and
an aqueous wash removal composition that is at least one of a surfactant wash, a solvent wash, a solvent surfactant wash, or a combination thereof.
